(19) United States
(12) Patent Application Publication
(10) Pub. No.: US 2013/0032760 A1
(43) Pub. Date: Feb. 7, 2013

(54) DEVICE AND METHOD FOR CONTROLLING THE PERMEATION OF OXYGEN THROUGH NON-POROUS CERAMIC MEMBRANES WHICH CONDUCT OXYGEN ANIONS, AND THE USE THEREOF

(71) Applicant: Steffen Werth, Solingen (DE)

(72) Inventor: Steffen Werth, Solingen (DE)

(21) Appl. No.: 13/516,061

(22) PCT Filed: Dec. 15, 2010
(86) PCT No.: PCT/EP2010/007696

§ 371 Date: Aug. 9, 2012

(30) Foreign Application Priority Data
Dec. 29, 2009 (DE) 10 2009 060 489.8

(51) Int. Cl. B01D 71/02; B01D 69/08; C09K 3/00; B01D 53/22

(52) U.S. Cl. 252/372; 95/54; 95/26; 96/4; 96/10; 95/1

(57) ABSTRACT

A process for regulating the rate of permeation of oxygen through a nonporous ceramic membrane which conducts oxygen anions and contains alkaline earth metal ions. On at least one side of the nonporous ceramic membrane which conducts oxygen anions, carbon dioxide and/or a gaseous carbon dioxide precursor is added for a predetermined time, which enables an alteration of the oxygen permeability of the membrane material. This brings about reversible chemical formation of alkaline earth metal carbonates in the membrane and, as a result, alters the properties thereof for oxygen permeation. A membrane reactor equipped with a feed line for a moderator gas can be regulated in a simple manner. The membrane reactor can preferably be used for oxidation reactions and/or for removal of oxygen from gas mixtures.

### CROSS-REFERENCE TO RELATED APPLICATIONS AND CLAIM FOR PRIORITY

This application is a National Phase Entry of International Patent Application No. PCT/EP2010/007696 (International Publication No. WO 2011/079913), filed Dec. 15, 2010, entitled (English translation): “Device and Method for Controlling the Permeation of Oxygen Through Non-Porous Ceramic Membranes Which Conduct Oxygen Anions, and the Use Thereof”. International Patent Application No. PCT/EP2010/007696 claims benefit of German Patent Application No. DE 10 2009 060 489.8, filed Dec. 29, 2009. The priorities of International Patent Application No. PCT/EP/2010/007696 and German Patent Application No. DE 10 2009 060 489.8 are hereby claimed and their disclosures incorporated herein by reference in their entireties.

### TECHNICAL FIELD

The present invention relates to an improved process for removing oxygen from gas mixtures by means of nonporous ceramic membranes which conduct oxygen anions, and to an improved reactor for performing chemical reactions.

### BACKGROUND

It is known that nonporous ceramic membranes which conduct oxygen anions can be used to remove oxygen from gas mixtures.

A subgroup of the nonporous ceramic membranes which conduct oxygen anions is that of (mixed-conducting) membranes which conduct oxygen anions and electrons, for example those with the ability to simultaneously conduct oxygen anions and electrons. These, for example, offer a means of removing oxygen from gas mixtures, for instance air.

The basic idea is a system in which a membrane is used to separate two gas spaces with different partial oxygen pressures. In operation, oxygen is ionized at the membrane on the side of the higher partial oxygen pressure (feed side) according to

O₂+4e⁻→2O²⁻ (1)

and transported via lattice defect sites in the crystal structure of the material to the side of the lower partial oxygen pressure (permeate side).

On the permeate side, the oxygen is then released again according to

2O²⁻→O₂+4e⁻ (2).

For each O₂ molecule released into the reaction chamber at the permeate side, the charge of 4e⁻ is released, which is transported to the feed side counter to the direction of oxygen ion flow.

In the case of mixed-conducting membranes, the charge is balanced by electron conduction within the membrane material itself.

Instead of mixed-conducting materials, composite materials composed of oxygen anion-conducting and electron-conducting materials are also known, in which the charge is balanced by means of an electron-conducting second phase in an intimate mixture with the material which conducts oxygen anions.

Likewise known are pure oxygen anion conductors, for instance yttrium-stabilized zirconium dioxide, where the charge is balanced during the oxygen permeation by means of an external circuit.

The materials for oxygen removal mentioned are typically ceramic materials which possess the ability to conduct oxygen anions at temperatures of usually >600° C.

Materials of this type may, for example, originate from the group of the perovskite (ABO₃) or perovskite-related structures, the aurivillius structures ([Bi₂O₂][Aₙ₋₁BₙOₓ]) or the brownmillerite structures (A₂B₂O₅).

Typical examples of systems described in the literature as oxygen-conducting materials are La₁₋ₓ(Ca,Sr,Ba)ₓCo_{1-y}Fe_{y}O_{3-δ}, Ba(Sr)Co₁₋ₓFeₓO_{3-δ}, Sr(Ba)Ti(Zr)_{1-x-y}, Co_{y}FeₓO_{3-δ}, La₁₋ₓSrₓGa_{1-y}Fe_{y}O_{3-δ6}, La_{0.5}Sr_{0.5}MnO_{3-δ}, LaFe(Ni)O_{3-δ}, La_{0.9}Sr_{0.1}FeO_{3-δ} or BaCoₓFe_{y}Zn_{1-x-y}O_{3-δ}. (A. Thursfield, I. S. Metcalfe, Journal of Material Science 2004, 14, 275-2485; Y. Teraoka, H. Zhang, S. Furukawa, N. Yamazoe, Chemistry Letters 1985, 1743-1746; Y. Teraoka, T. Nobunaga, K. Okamoto, N. Miura, N. Yasmazoe, Solid State Ionics 1991, 48, 207-212; J. Tong, W. Yang, B. Zhu, R. Cai, Journal of Membrane Science 2002, 203, 175-189).

It is known that the rate of oxygen permeation depends not only on the composition of the membrane but also strongly on the operating conditions (T. Schiestel, M. Kilgus, S. Peter, K. J. Caspary, H. Wang, J. Caro, Journal of Membrane Science 2005, 258, 1-4).

Of particular significance in this context is the temperature, which generally has a linear to exponential influence on the rate of oxygen permeation.

One possible application of such membranes is obtaining synthesis gas by partial oxidation of hydrocarbons (e.g. WO 2007/068369 A1).

Other possible uses lie, for example, in obtaining oxygen-enriched air (e.g. DE 10 2005 006 571 A1), oxidative dehydrogenation of hydrocarbons or hydrocarbon derivatives, oxidative coupling of methane or obtaining oxygen for power plant applications (H. Wang, Y. Cong, X. Zhu, W. Yang, React. Kinet. Catal. Lett. 2003, 79, 351-356; X. Tan, K. Li, Ind. Eng. Chem. Res. 2006, 45, 142-149; R. Bredesen, K. Jordal, O. Bolland, Chemical Engineering and Processing 2004, 43, 1129-1158).

In the removal of oxygen from gas mixtures and the optionally subsequent oxidation of a gaseous reactant, for example in the preparation of synthesis gas by the partial oxidation of hydrocarbons, it is possible to use a membrane reactor which is divided by a ceramic membrane which conducts oxygen anions into two spaces, known as the feed space and the permeate space. The ceramic membrane thus has a feed side and a permeate side.

In operation, an oxygen-supplying gas (mixture) or an oxygen-containing gas mixture, for example air, is initially charged on the feed side of the ceramic membrane, and an oxidizable medium, for instance methane, which may optionally be mixed with further components, such as water vapor, on the permeate side. In operation, oxygen permeates from the side of the higher partial oxygen pressure through the membrane into the permeate space and reacts with the oxidizable medium therein.

Alternatively, the oxidizable medium can be supplied to the oxygen-enriched gas mixture only downstream of the permeate space.

Since the oxygen on the permeate side is constantly depleted or removed, the partial oxygen pressure of the permeate side is below the partial oxygen pressure of the feed side.

Therefore, for example, air can be used on the feed side with more or less any pressure, while a significantly elevated pressure exists at the same time on the permeate side. The lower limit for the pressure on the feed side is that the partial oxygen pressure of the feed side must be above the partial oxygen pressure of the permeate side.

In order to achieve acceptable reaction rates and hence also integral selectivities on the permeate side in the performance of oxidation reactions, for example in the preparation of synthesis gas, a suitable catalyst is typically used in the reaction chamber of the reactor. Examples thereof can be found, for instance, in EP 0 999 180 A2, EP 1 035 072 A1, U.S. Pat. No. 6,077,323 or U.S. Pat. No. 6,695,983.

U.S. Pat. No. 5,240,473 A discloses that the permeability for oxygen anions through membranes composed of multicomponent metal oxides at high temperatures can decrease. This is caused by reaction of membrane constituents with carbon dioxide, water or hydrocarbons. This patent proposes re-establishing the permeability of the membrane by heating the membrane to temperatures of greater than 810° C. for a particular time and hence keeping it above the operating temperatures of 600 to 800° C. By repeated heating at preset operating intervals, it is possible to re-establish and hence secure in a permanent manner the permeability of the membrane.

A main problem with the ceramic membrane reactors described arises from the regulation of the system.

In correct operation, there may be recurring situations where the oxygen permeation through the membrane has to be varied or even has to be temporarily stopped completely. A typical scenario for this is maintenance work on plant constituents outside the membrane reactor.

A further scenario is the absorption of temperature variations in the membrane reactor. When there is an increase in the operating temperature due to external influences during operation, the rate of oxygen permeation through the ceramic membrane increases.

As a result, the chemical reaction on the permeate side is accelerated. In the case of exothermic reactions, this conversion releases heat, as a result of which the temperature rises again. If such an operating state cannot be absorbed by appropriate regulation, the result may be runaway of the reaction in the membrane reactor.

There exist a number of options for influencing oxygen permeation and hence the reaction in the membrane reactor.

For example, the operating temperature of the membrane reactor or the gas supply on the feed side can be varied.

The known variants for regulation of reactor operation, however, have considerable disadvantages. For example, cooling of the membrane reactor under some circumstances leads to the development of thermal stresses, which can especially subject the critical membrane-reactor jacket connection to severe stress. In order to reduce these stresses, efforts are therefore made to minimize the number of heating and cooling cycles of a membrane reactor, since too great a number of temperature cycles is at the expense of the lifetime of the membrane reactor.

It is likewise problematic to reduce the gas supply on the feed side. As soon as the supply of the oxygen-containing feed gas is ended, the transport of the oxygen through the ceramic membrane stops. Since the ceramic membrane is itself a chemical compound, for example an oxygen compound, this leads under some circumstances to reduction of the membrane on the permeate side and hence to disruption of the membrane material.

It is therefore an object of the present invention to provide a simple means of regulating the rate of permeation of oxygen through nonporous ceramic membranes which conduct oxygen anions.

### SUMMARY OF INVENTION

The present invention therefore relates to a process for regulating the permeation rate of oxygen anions through a nonporous ceramic membrane which conducts oxygen anions.

The process is characterized in that a nonporous ceramic membrane which conducts oxygen anions and contains alkaline earth metal ions is used, and in that carbon dioxide and/or a gaseous carbon dioxide precursor is added for a predetermined time on at least one side of the nonporous ceramic membrane which conducts oxygen anions, which enables an alteration of the oxygen permeability of the membrane material.

A preferred embodiment of the process according to the invention for regulating the permeation rate of oxygen anions through a nonporous ceramic membrane which conducts oxygen anions is characterized in that the membrane is surrounded on both sides by an oxygen-containing gas, in that a nonporous ceramic membrane which conducts oxygen anions and contains alkaline earth metal ions is used, and in that at least one side of the nonporous ceramic membrane which conducts oxygen anions is contacted with gaseous carbon dioxide for a predetermined time at temperatures between 400 and 900° C., such that the permeation rate of oxygen anions in the nonporous ceramic membrane which conducts oxygen anions is reduced.

Without being bound to a theory, it is assumed that the carbon dioxide reacts with the membrane material, such that alkaline earth metal carbonates form in the ceramic membrane under the reaction conditions. This process is reversible and the permeation rate of oxygen anions increases again as soon as no further carbon dioxide can react with the membrane material.

Still further features and advantages will become apparent from the discussion which follows.

### BRIEF DESCRIPTION OF DRAWINGS

The invention is described in detail below with reference to the Figures, in which:

FIG. 1 illustrates the relationship between oxygen permeation and CO₂ addition; and

FIG. 2 shows the formation of BaCO₃ in the presence of free CO₂ as a function of temperature.

### DETAILED DESCRIPTION

The invention is described in detail below with reference to several embodiments and numerous examples. Such discussion is for purposes of illustration only. Modifications to examples within the spirit and scope of the present invention, set forth in the appended claims, will be readily apparent to one of skill in the art. Terminology used throughout the specification and claims herein is given its ordinary meaning as supplemented by the discussion immediately below.

The expression “permeation rate of oxygen anions” is understood in the context of this description to mean the permeability of the ceramic membrane for oxygen per unit area and per unit time.

The ceramic membrane can be contacted with gaseous carbon dioxide in different ways. For instance, a selected amount of gaseous carbon dioxide can be added to the oxygen-containing gas for a particular time interval, or the oxygen-containing gas can be replaced by gaseous carbon dioxide for a particular time interval. Instead of gaseous carbon dioxide, it is possible to use a combination of oxygen-containing gas with gaseous precursor of carbon dioxide, for example of gaseous carbon monoxide or of other gaseous carbon-containing compounds, such as hydrocarbons. These gaseous precursors react with the oxygen under the conditions in the membrane reactor to give carbon dioxide, such that carbon dioxide ultimately comes into contact with the membrane.

The oxygen-containing gas can be replaced for a predetermined period by gaseous carbon dioxide and/or by a mixture comprising oxygen and a gaseous precursor of carbon dioxide, by purging the ceramic membrane continuously with a gas stream which comprises carbon dioxide and/or an oxygen/carbon dioxide precursor mixture. The purging can also be effected at predetermined time intervals, i.e. in a pulsed manner.

The membranes used in accordance with the invention are nonporous, although limitations, for instance in the production process, may also result in minor leaks through pores.

What is crucial, however, is that the main effect of the material separation results from an interaction between the oxygen to be removed and the nonporous ceramic membrane material.

The mixed conductors mentioned for oxygen removal are typically ceramic materials which possess the ability to conduct oxygen anions at temperatures of typically >600° C.

The operating temperatures for such ceramic membranes are typically above 600° C., preferably in the range from 700 to 900° C. and most preferably in the range from 800 to 900° C.

In a particularly preferred embodiment of the process according to the invention, the operating temperature of the ceramic membrane is set within a narrow range, for example within a range of ±80° C., preferably ±50° C., more preferably ±30° C., and the permeation rate of the ceramic membrane for oxygen is regulated by the variation of the carbon dioxide concentration on at least one side of the ceramic membrane.

The nonporous ceramic membranes which conduct oxygen anions are preferably those types which conduct both oxygen anions and electrons.

To moderate the oxygen permeability through the ceramic membrane, preference is given to using gaseous carbon dioxide. A further preferred moderator gas is a mixture of oxygen and gaseous carbon monoxide.

The form of the nonporous ceramic membrane which conducts oxygen anions may be as desired. It may comprise thin and flat membranes, or preferably ceramic hollow fibers.

The nonporous ceramic membranes which conduct oxygen anions may be any material suitable therefor.

They preferably comprise an oxide ceramic with pervoskite structure or with brownmillerite structure or with aurivillius structure.

Oxide ceramics used with preference have a perovskite structure ABO_{3-δ} where A represents divalent cations and B represents trivalent or higher-valency cations, the ionic radius of A is greater than the ionic radius of B and δ is a number from 0.01 to 0.9, preferably from 0.01 to 0.5, in order to establish the electrical neutrality of the material, where A and/or B may be present as mixtures of different cations.

Further oxide ceramics used with preference have a brownmillerite structure A₂B₂O_{5-δ} where A represents divalent cations and B represents trivalent or higher-valency cations, the ionic radius of A is greater than the ionic radius of B and δ is a number from 0.01 to 0.9, preferably from 0.01 to 0.5, in order to establish the electrical neutrality of the material, where A and/or B may be present as mixtures of different cations.

In these aforementioned preferred types, the A type cations are especially selected from cations of the second main group, the first transition group, the second transition group, the lanthanides or mixtures of these cations, preferably from Mg²⁺, Ca²⁺, Sr²⁺, Ba²⁺, Cu²⁺, Ag²⁺, Zn²⁺, Cd²⁺ and/or the lanthanides.

In these aforementioned preferred types, the type B cations are especially selected from cations of groups IIIB to VIIIB of the Periodic Table and/or the lanthanide group, the metals of the fifth main group or mixtures of these cations, preferably from Fe³⁺, Fe^{4+,} Ti³⁺, Ti⁴⁺, Zr³⁺, Zr⁴⁺, Ce³⁺, Ce⁴⁺, Mn³⁺, Mn⁴⁺, Co²⁺, Co³⁺, Nd³⁺, Nd⁴⁺, Gd³⁺, Gd⁴⁺, Sm³⁺, Sm⁴⁺, Dy³⁺, Dy⁴⁺, Ga³⁺, Yb³⁺, Al³⁺, Bi⁴⁺ or mixtures of these cations.

In a particularly preferred embodiment, the nonporous ceramic membrane which conducts oxygen anions comprises barium.

It is most preferably a nonporous ceramic membrane which conducts oxygen anions and consists of BaCoₓFe_{y}Zr_{z}O₃₋₆ in which x, y and z are real numbers, x+y+z=1 and δ is a number from 0.01 to 0.9, preferably from 0.01 to 0.5, in order to establish the electrical neutrality of the material.

The process according to the invention may be used in any desired arrangements in which the rate of oxygen permeation through a nonporous ceramic membrane which conducts oxygen anions has to be controlled.

Particular preference is given to a process in which the nonporous ceramic membrane which conducts oxygen anions is part of a membrane reactor and in which a carbon dioxide- and/or oxygen- and carbon monoxide-containing moderator gas is added at predetermined time intervals or continuously on at least one side of the membrane and enters into a reversible chemical reaction with the nonporous ceramic membrane which conducts oxygen anions to form alkaline earth metal carbonates, and wherein the concentration of the moderator gas is adjusted such that it influences the rate of the oxygen permeating through the membrane in the desired manner.

In a particularly preferred embodiment of the process according to the invention, a moderator gas which forms as a result of chemical reaction in the permeation space is used. This can be used to protect the membrane reactor from undesired thermal runaway.

For example, in the case of synthesis gas preparation based on a membrane composed of BaCoₓFe_{y}Zr_{z}O_{3-δ} (x+y+z=1) in correct operation, the amount of added methane can be adjusted with respect to the oxygen permeation through the membrane such that the partial oxidation in the permeation space in standard operation proceeds up to the formation of CO. In the case of an increase in the oxygen permeation, for instance as a result of an increase in the operating temperature, there is additional formation of CO₂, which hinders oxygen permeation through the membrane.

A further variant of the process according to the invention consists in adding an appropriate amount of moderator gas, for example CO₂, continuously to the feed stream of the nonporous ceramic membrane on the permeate side upstream of the reactor inlet, such that an increase in the CO₂ concentration in the reactor beyond the desired degree results in blocking of the membrane.

A further variant of the process according to the invention comprises the pulsed addition of the moderator gas over time. According to the duration and time between the moderator gas pulses, it is thus possible to adjust the oxygen permeation through the membrane on average over time.

A further configuration of the invention relates to a membrane reactor of particular configuration. This comprises the following elements:
A) at least one nonporous ceramic membrane which conducts oxygen anions, comprising alkaline earth metal ions, which is present in a reaction chamber and divides it into a feed gas space and a permeate gas space,
B) at least one feed line for an oxygen-containing feed gas mixture, which is connected to the feed gas space,
C) at least one draw line for a feed gas mixture depleted of oxygen, which is connected to the feed gas space,
D) at least one feed line for a purge gas or reaction gas mixture, which is connected to the permeate gas space,
E) at least one draw line for a purge gas or reaction gas mixture enriched with oxygen, which is connected to the permeate gas space,
F) at least one feed line for gaseous carbon dioxide and/or for a gaseous precursor of carbon dioxide, which is connected to the feed gas space and/or the permeate gas space and/or to the feed line to the feed gas space and/or the feed line to the permeate gas space,
G) at least one control device for adjusting of the content of gaseous carbon dioxide in the gas space, which adjoins at least one surface of the ceramic membrane, and
H) the membrane reactor additionally has a sensor with which the permeation rate of the oxygen through the nonporous ceramic membrane which conducts oxygen anions can be determined.

One example of a control device G) is a mass flow controller.

In a particularly preferred configuration, the membrane reactor additionally has I) a regulator which permits the adjustment of the content of gaseous carbon dioxide introduced into the gas space by control device G) as a function of the permeation rate of the oxygen through the membrane determined by sensor H). Such regulators are commercially available.

The content of carbon dioxide introduced into the gas space G) can be adjusted by means of the control device by methods known per se. For this purpose, the concentration of carbon dioxide or of carbon dioxide precursor is determined. In addition to the conventional methods of precipitation reactions, it is also possible to measure the CO₂ or CO₂ precursor contents in gases by means of gas chromatography analyses. This is advisable for control systems and slow regulation systems. For rapidly responding regulation systems, online IR measurement is advisable for determination of the content of CO₂ or of CO₂ precursor, such as CO.

Alternatively, the content of CO₂ or of CO₂ precursor can be determined by means of flow measurement. The flow can be detected, for example, via measurement principles such as thermal mass flow measurement, i.e. by use of a mass flow controller, by coriolis mass measurement, or by means of variable area flowmeters.

The CO₂ content in the gas space is regulated, i.e. the required concentration is established, typically by means of a software-controlled regulator. For example, a software-controlled regulating valve is used to establish the appropriate flow. In the case of use of a mass flow controller, the regulator valve is integrated in one unit with the flow measuring unit.

The apparatuses described are commercially available products.

Sensor H) may be a temperature sensor with which the temperature can be measured in the permeate space. If, for example, in an exothermic oxidation reaction with the same concentration of oxidizable reactant, the temperature in the permeation space rises, this is an indication of enhanced oxygen permeation through the membrane. Alternatively, the concentration of oxygen in the depleted feed stream from the feed space and/or the concentration of the oxidation product from the permeate space can also be determined. These measurements can be used individually or in combination as regulation parameters, in order to control the coverage of the membrane surface with moderator gas. The concentration of oxygen in the gas space or the concentration of the oxidation product in the gas space can be determined by the same measurement principles which have been described above for the determination of the content of CO₂ or of CO₂ precursor in the gas space.

The invention also relates to the use of the above-described membrane reactor for removing oxygen from gas mixtures, preferably from air, or for performing oxidation reactions in the gas phase.

The oxygen removed is preferably used for the subsequent performance of an oxidation reaction in the gas phase.

The preferred oxidation reactions are, for example, the partial oxidation of a hydrocarbon-containing gas mixture to prepare synthesis gas, or the oxidative dehydrogenation of hydrocarbons, or the oxidative coupling of methane.

In a further preferred embodiment, the invention relates to the use of the above-described membrane reactor to obtain oxygen for power plant applications.

The example which follows and the figures illustrate the invention without restricting it thereby. They show:

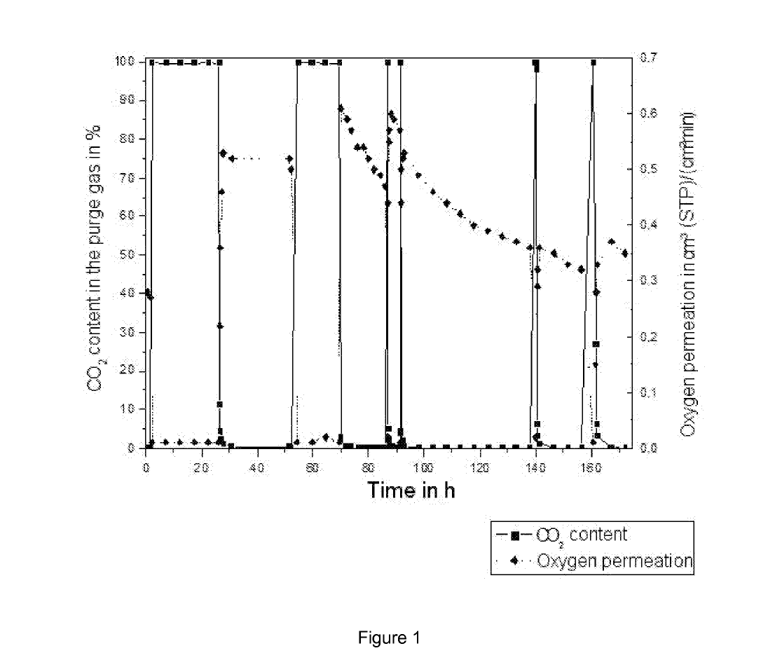

FIG. 1: the rate of oxygen permeation through a membrane as a function of the content of CO₂ moderator gas in the permeate space;

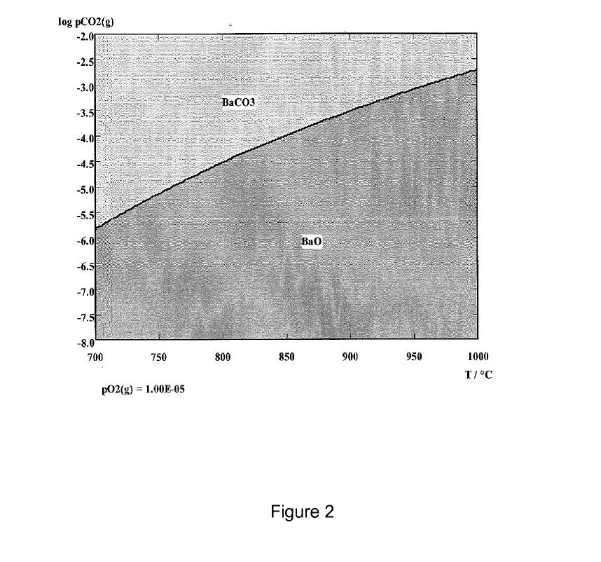

FIG. 2: range of BaCO₃ formation in the presence of free CO₂ as a function of temperature.

### EXAMPLE

The oxygen permeation through a ceramic membrane can be influenced in accordance with the invention, in the case of a membrane based on a Ba-containing compound, for instance BaCoₓFe_{y}Zr_{z}O_{3-δ} (x+y+z=1) (J. Tong, W. Yang, Z. Shao, G. Xiong, L. Lin, Chinese Science Bulletin 2001, 46, 473-477) or Ba_{0.5}Sr_{0.5}Co_{0.8}Fe_{0.2}0_{3-δ} (M. Arnold, H. Wang, A. Feldhoff, Journal of Membrane Science 2007, 293, 44-52) by the addition of CO₂ as a moderator gas on the permeate side of the membrane. As will be shown below, this addition leads to a reversible reduction in the oxygen permeability.

A ceramic hollow fiber membrane with a diameter of 1.24 mm (T. Schiestel, M. Kilgus, S. Peter, K. J. Caspary, H. Wang, J. Caro, Journal of Membrane Science 2005, 258, 1-4) was purged with 150 ml/min of air at a temperature of 850° C. on the inside. The inert purge gas introduced on the outside was alternately 30 ml/min of argon or CO₂.

FIG. 1 shows the oxygen permeation obtained as a function of the CO₂ addition. In addition of CO₂ as a moderator gas, the oxygen permeation was reduced to zero within a very short period. As soon as the addition of CO₂ on the permeate side had been ended, the oxygen permeation rose again in an equally short period.

The effect described is attributable to the reversible formation of BaCO₃ in the presence of CO₂, which blocks the membrane surface and prevents oxygen permeation even at high temperatures. As soon as the CO₂ concentration falls below the equilibrium concentration of BaCO₃ at the appropriate operating temperature, BaCO₃ decomposes, and oxygen permeation is re-established.

FIG. 2 shows the range of formation of BaCO₃ in the presence of free CO₂ as a function of temperature.

The amount of BaCO₃ formed—and hence the extent of reduction in the rate of oxygen permeation—depends, inter alia, on the mean partial pressure of the CO₂ in the gas phase. Thus, in the case of suitable selection of the partial CO₂ pressure, it is possible in a controlled manner to only partly or temporarily block the membrane surface and hence partly or temporarily prevent oxygen permeation. In this way, it is possible to adjust the effective oxygen permeation (or oxygen supply) and hence the extent of the reaction on the permeate side within a wide range.

While the invention has been described in detail, modifications within the spirit and scope of the invention will be readily apparent to those of skill in the art. Such modifications are also to be considered as part of the present invention. In view of the foregoing discussion, relevant knowledge in the art and references discussed above in connection with the Background of the Invention, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

1. A process for regulating the permeation rate of oxygen anions through a nonporous ceramic membrane which conducts oxygen anions, characterized in that a nonporous ceramic membrane which conducts oxygen anions and contains alkaline earth metal ions is used, and in that carbon dioxide and/or a gaseous carbon dioxide precursor is added for a predetermined time on at least one side of the nonporous ceramic membrane which conducts oxygen anions, which enables an alteration of the oxygen permeability of the membrane material.

2. The process as claimed in claim 1, characterized in that the nonporous ceramic membrane which conducts oxygen anions is surrounded on both sides by an oxygen-containing gas, in that at least one side of the nonporous ceramic membrane which conducts oxygen anions is contacted with gaseous carbon dioxide for a predetermined time at temperatures between 400 and 900° C., such that the permeation rate of oxygen anions in the nonporous ceramic membrane which conducts oxygen anions is reduced.

3. The process as claimed in claim 1, characterized in that gaseous carbon dioxide and/or another gaseous, carbon-containing compound is added to the oxygen-containing gas on at least one side of the nonporous ceramic membrane which conducts oxygen anions, or in that the oxygen-containing gas is replaced on at least one side of the nonporous ceramic membrane which conducts oxygen anions by gaseous carbon dioxide and/or by another gaseous, carbon-containing compound.

4. The process as claimed in claim 1, characterized in that the oxygen-containing gas on either side of the nonporous ceramic membrane which conducts oxygen anions has different oxygen concentrations, and in that gaseous carbon dioxide and/or gaseous carbon monoxide is added to the gas having the lower oxygen concentration or in that the gas having the lower oxygen concentration is replaced for a predetermined time by gaseous carbon dioxide and/or by gaseous carbon monoxide.

5. The process as claimed in claim 1, characterized in that the operating temperature of the ceramic membrane is set within a range of ±80° C., and in that the permeation rate of the ceramic membrane for oxygen is regulated by the variation of the carbon dioxide concentration on at least one side of the ceramic membrane.

6. The process as claimed in claim 1, characterized in that the nonporous ceramic membrane which conducts oxygen anions is a ceramic membrane which conducts oxygen anions and electrons.

7. The process as claimed in claim 1, characterized in that the nonporous ceramic membrane which conducts oxygen anions is used in the form of a ceramic hollow fiber.

8. The process as claimed in claim 1, characterized in that the nonporous ceramic membrane which conducts oxygen anions is formed from an oxide ceramic with perovskite structure or with brownmillerite structure or with aurivillius structure.

9. The process as claimed in claim 8, characterized in that the oxide ceramic has a perovskite structure ABO_{3-δ} where A represents divalent cations and B represents trivalent or higher-valency cations, the ionic radius of A is greater than the ionic radius of B and δ is a number from 0.01 to 0.9, preferably from 0.01 to 0.5, in order to establish the electrical neutrality of the material, where A and/or B may be present as mixtures of different cations, and where at least some of the cations A are alkaline earth metal cations, or in that the oxide ceramic has a brownmillerite structure A₂B₂O_{5-δ} where A represents divalent cations and B represents trivalent or higher-valency cations, the ionic radius of A is greater than the ionic radius of B and δ is a number from 0.01 to 0.9, preferably from 0.01 to 0.5, in order to establish the electrical neutrality of the material, where A and/or B may be present as mixtures of different cations, and where at least some of the cations A are alkaline earth metal cations, where the type A cations in these oxide ceramics are preferably selected from the cations of the second main group, of the first transition group, of the second transition group, of the lanthanides or mixtures of these cations, more preferably from Mg²⁺, Ca²⁺, Sr²⁺, Ba²⁺, Cu²⁺, Ag²⁺, Zn²⁺, Cd²⁺ and/or the lanthanides, and where at least some of the cations A are Mg²⁺, Ca²⁺, Sr²⁺ and/or Ba²⁺, and/or where the type B cations in these oxide ceramics are preferably selected from cations of groups IIIB to VIIIB of the Periodic Table and/or the lanthanide group, the metals of the fifth main group or mixtures of these cations, more preferably from Fe³⁺, Fe^{4+,} Ti³⁺, Ti⁴⁺, Zr³⁺, Zr⁴⁺, Ce³⁺, Ce⁴⁺, Mn³⁺, Mn⁴⁺, Co²⁺, Co³⁺, Nd³⁺, Nd⁴⁺, Gd³⁺, Gd⁴⁺, Sm³⁺, Sm⁴⁺, Dy³⁺, Dy⁴⁺, Ga³⁺, Yb³⁺, Al³⁺, Bi⁴⁺ or mixtures of these cations.

10. The process as claimed in claim 8, characterized in that the nonporous ceramic membrane which conducts oxygen anions consists of BaCoₓFe_{y}Zr_{z}O_{3-δ} in which x, y and z are real numbers, x+y+z=1 and δ is a number from 0.01 to 0.9, preferably from 0.01 to 0.5, in order to establish the electrical neutrality of the material.

11. The process as claimed in claim 1, characterized in that the nonporous ceramic membrane which conducts oxygen anions is part of a membrane reactor, and in that gaseous carbon dioxide and/or gaseous carbon monoxide is added at predetermined time intervals or continuously on at least one side of the membrane, and wherein the concentration of the carbon dioxide and/or of the carbon monoxide is adjusted such that it influences the rate of the oxygen permeating through the membrane.

12. The process as claimed in claim 11, characterized in that predetermined amounts of gaseous carbon dioxide and/or of gaseous carbon monoxide are added at predetermined time intervals to the feed stream of the nonporous ceramic membrane which conducts oxygen anions on the feed side and/or on the permeate side.

13. A membrane reactor comprising the following elements:
A) at least one nonporous ceramic membrane which conducts oxygen anions, comprising alkaline earth metal ions, which is present in a reaction chamber and divides it into a feed gas space and a permeate gas space,
B) at least one feed line for an oxygen-containing feed gas mixture, which is connected to the feed gas space,
C) at least one draw line for a feed gas mixture depleted of oxygen, which is connected to the feed gas space,
D) at least one feed line for a purge gas or reaction gas mixture, which is connected to the permeate gas space,
E) at least one draw line for a purge gas or reaction gas mixture enriched with oxygen, which is connected to the permeate gas space,
F) at least one feed line for gaseous carbon dioxide and/or for a gaseous precursor of carbon dioxide, which is connected to the feed gas space and/or the permeate gas space and/or to the feed line to the feed gas space and/or the feed line to the permeate gas space,
G) at least one control device for adjusting the content of gaseous carbon dioxide in the gas space, which adjoins at least one surface of the ceramic membrane, and
H) the membrane reactor additionally has a sensor with which the permeation rate of the oxygen through the nonporous ceramic membrane which conducts oxygen anions can be determined.

14. The membrane reactor as claimed in claim 13, characterized in that the nonporous ceramic membrane which conducts oxygen anions is an electron-conducting membrane which conducts oxygen anions.

15. The membrane reactor as claimed in claim 13, characterized in that the membrane reactor additionally has I) a regulating unit which permits the adjustment of the gaseous carbon dioxide introduced into the gas space by control device G) as a function of the permeation rate of the oxygen through the membrane determined by sensor H).

16. The membrane reactor as claimed in claim 13, characterized in that the feed line F) is connected to a CO₂ source at the opposite end from the membrane reactor.

17. The membrane reactor as claimed in claim 13, characterized in that the at least one nonporous ceramic membrane which conducts oxygen anions is in the form of a ceramic hollow fiber.

18. The membrane reactor as claimed in claim 13, characterized in that the nonporous ceramic membrane which conducts oxygen anions consists of an oxide ceramic with perovskite structure or with brownmillerite structure or with aurivillius structure, preferably in that the oxide ceramic has a perovskite structure ABO_{3-δ} where A represents divalent cations and B represents trivalent or higher-valency cations, the ionic radius of A is greater than the ionic radius of B and δ is from 0.01 to 0.9, preferably from 0.01 to 0.5, in order to establish the electrical neutrality of the material, and where A and/or B may be present as mixtures of different cations, or preferably in that the oxide ceramic has a brownmillerite structure A₂B₂O_{5-δ} where A represents divalent cations and B represents trivalent or higher-valency cations, the ionic radius of A is greater than the ionic radius of B and δ is from 0.01 to 0.9, preferably from 0.01 to 0.5, in order to establish the electrical neutrality of the material, and where A and/or B may be present as mixtures of different cations.

19. The membrane reactor as claimed in claim 18, characterized in that the type A cations are selected from cations of the second main group, of the first transition group, of the second transition group, of the lanthanides or mixtures of these cations, preferably from Mg²⁺, Ca²⁺, Sr²⁺, Ba²⁺, Cu²⁺, Ag²⁺, Zn²⁺, Cd²⁺ and/or the lanthanides, and/or in that the type B cations are selected from cations of groups IIIB to VIIIB of the Periodic Table and/or of the lanthanide group, the metals of the fifth main group or mixtures of these cations, preferably from Fe³⁺, Fe^{4+,} Ti³⁺, Ti⁴⁺, Zr³⁺, Zr⁴⁺, Ce³⁺, Ce⁴⁺, Mn³⁺, Mn⁴⁺, Co²⁺, Co³⁺, Nd³⁺, Nd⁴⁺, Gd³⁺, Gd⁴⁺, Sm³⁺, Sm⁴⁺, Dy³⁺, Dy⁴⁺, Ga³⁺, Yb³⁺, Al³⁺, Bi⁴⁺ or mixtures of these cations.

20. The membrane reactor as claimed in claim 18, characterized in that the nonporous ceramic membrane which conducts oxygen anions consists of BaCoₓFe_{y}Zr_{z}O_{3-δ} in which x, y and z are real numbers, x+y+z=1 and δ is a number from 0.01 to 0.9, preferably from 0.01 to 0.5, in order to establish the electrical neutrality of the material.

21. A method for removing oxygen from gas mixtures, especially from air, or for performing oxidation reactions in the gas phase, comprising:
(a) providing a membrane reactor with the following elements:
i. at least one nonporous ceramic membrane which conducts oxygen anions, comprising alkaline earth metal ions, which is present in a reaction chamber and divides it into a feed gas space and a permeate gas space,
ii. at least one feed line for an oxygen-containing feed gas mixture, which is connected to the feed gas space,
iii. at least one draw line for a feed gas mixture depleted of oxygen, which is connected to the feed gas space,
iv. at least one feed line for a purge gas or reaction gas mixture, which is connected to the permeate gas space,
v. at least one draw line for a purge gas or reaction gas mixture enriched with oxygen, which is connected to the permeate gas space,
vi. at least one feed line for gaseous carbon dioxide and/or for a gaseous precursor of carbon dioxide, which is connected to the feed gas space and/or the permeate gas space and/or to the feed line to the feed gas space and/or the feed line to the permeate gas space,
vii. at least one control device for adjusting the content of gaseous carbon dioxide in the gas space, which adjoins at least one surface of the ceramic membrane, and
viii. the membrane reactor additionally has a sensor with which the permeation rate of the oxygen through the nonporous ceramic membrane which conducts oxygen anions can be determined; and
(b) removing oxygen from a gas mixture fed to the membrane reactor or utilizing the reactor in connection with a gas phase oxidation reaction.

22. The method as claimed in claim 21, characterized in that oxygen removed is used for the subsequent performance of an oxidation reaction in the gas phase.

23. The method as claimed in claim 21, characterized in that the oxygen removed is used for power plant applications.

24. The method as claimed in claim 22, characterized in that the oxidation reaction is a partial oxidation of a hydrocarbon-containing gas mixture to prepare synthesis gas, or is an oxidative dehydrogenation of hydrocarbons, or is an oxidative coupling of methane.
